(19) United States
(12) Patent Application Publication
(10) Pub. No.: US 2018/0360082 A1
(43) Pub. Date: Dec. 20, 2018

(54) SYNERGISTIC BINDING AND THICKENING AGENT FOR TOMATO BASED SAUCES

(71) Applicants: KURT VILLWOCK, Hudson, WI (US); BROCK LUNDBERG, Hudson, WI (US)

(72) Inventors: KURT VILLWOCK, Hudson, WI (US); BROCK LUNDBERG, Hudson, WI (US)

(21) Appl. No.: 15/625,123

(22) Filed: Jun. 16, 2017

(51) Int. Cl. A23L 19/00; A23L 23/00; A23L 3/02

(52) U.S. Cl. CPC A23L 19/09; A23V 2002/00; A23L 3/02; A23L 23/00

(57) ABSTRACT

A method for adjusting the viscosity and binding of a tomato sauce, reducing tomato solids, and a resulting tomato sauce is prepared. A tomato paste solids is mixed with water and optionally spices. A highly refined cellulose fiber or particle having a water holding capacity of at least 20 grams of water per gram of highly refined cellulose to bind any free water and oil, which is mixed by agitation until uniformly mixed with the water and tomato paste mixture to form a pre-pasteurization mixture of tomato paste and at least 0.2% by weight of the highly refined cellulose. The pre-pasteurization mixture is pasteurized by heat to form a pasteurized mixture. While the hot pasteurized mixture is hot, it is homogenized. Pressure is increased during homogenization to lower Bostwick consistency.

### BACKGROUND OF THE INVENTION

### 1. Field of the Invention

The present invention relates to the field of food technology, specifically tomato sauce technology, and controlling the thickening of tomato sauces under different pressure mixing conditions.

### 2. Background of the Art

Even the most casual consumers of food are well aware of the quality of different foods that they eat. Not only are flavors critical to satisfaction of the palate, but color, consistency, mouth-feel, and appearance are important. Even though all cooks and chefs may have access to identical ingredients, products of vastly different levels of consumer satisfaction can be created.

One particular area of food preparation that is highly complex in its ability to be controlled is the balance between moistness, consistency, viscosity and liquidity. It is relatively simple to adjust a single factor, but many adjustments create an imbalance in another factor. One can easily reduce the liquidity of a sauce by boiling off water, but this may concentrate ingredients undesirably or create a pasty product that does not provide a satisfactory feel to the consumer. This complexity is also highly important and more complicated with respect to the most common ingredient for sauces, tomatoes and tomato pastes used in sauces. The acidity and solids components in tomatoes make them aa difficult commodity to control properties in sauces. Many different chemical treatments of sauces have been attempted, especially where mere addition of starches to increase viscosity or binding free water/oil have not proven satisfactory, which also lighten the color of the sauce

U.S. Pat. No. 5,902,616 describes a process for preparing fresh tomato sauce and the sauce prepared thereby. In the process, diced tomatoes and a tomato puree are combined in a kettle including firming salts, water and pectinase. Particularly when processed tomatoes are used in making the tomato sauce, cellulose gels were found. These were confirmed by dissolving the gels with cellulose. Therefore it was felt that some cellulase would be useful in controlling the tomato sauce gel. However, we have found that the gel from pectin was on such a larger scale than gels from cellulose that the pectinase become the preferred enzyme of choice.

U.S. Pat. No. 6,004,591 describes a freshly packed, sterilized tomato sauce comprising diced tomatoes and pectinase, said tomatoes not having been pectin enzyme heat deactivated prior to sterilization, said fresh packed tomato sauce having Bostwick viscosity of from 5 to 7. In the process, diced tomatoes and a tomato puree are combined in a kettle including firming salts, water and pectinase.

In Md. Khayrul Alam, Maruf Ahmed, Mst. Sorifa Akter, Nurul Islam and Jong-Bang Eun, 2009. Effect of Carboxymethylcellulose and Starch as Thickening Agents on the Quality of Tomato Ketchup. Pakistan Journal of Nutrition, 8: 1144-1149, the effect of thickening agents such as carboxymethylcellulose and starch on the quality parameter of tomato ketchup during storage at 30° C. was evaluated. The carboxymethylcellulose was used at the rate of 0.75-1.25% while, starch was 3-4% in the formulation of tomato ketchup. The moisture content of ketchup was increased by the addition of both the thickening agents. The protein, fibre, ash, acidity and total soluble solid of tomato ketchup were decreased gradually when higher percentage of starch and carboxymethylcellulose were added.

U.S. Pat. No. 7,348,036 (Messager) describes a full waxy wheat flour or starch useful in making sauces characterized in that its amylose content is about 0%±about 1%, and a process for preparing a functional full waxy wheat flour including preparing an initial flour with a defined size grading starting from full waxy wheat grains, and subjecting the flour to a heat-moisture treatment including adding water or steam and heat energy to achieve a degree of gelatinization of starch between about 15 and about 99% for less than about 5 minutes. The difficulty in making stable consistency sauces is noted.

U.S. Pat. No. 6,863,908 (Hamm) describes a universal sauce base, i.e. an edible composition, having a low pH for use in hot or cold food applications that is microbiologically stable, heat stable and freeze-thaw tolerant. The universal sauce base has an oil-in-water emulsion and comprises water, vegetable oil, starch, phospholipase A2 modified egg yolk and inorganic acid acidulent including at least phosphoric acid and other ingredients. The universal sauce base has a bland and non-sour flavor, can be used in a wide variety of food applications and can be combined with a wide range of flavors and other ingredients.

U.S. Pat. No. 6,004,591 (Hinnergardt) describes a process for preparing fresh tomato sauce and the sauce prepared thereby. The sauce has a fresh taste and has good viscosity even though diced tomatoes provided therein are not subjected to an enzyme deactivation heating step. In the process, diced tomatoes and a tomato puree are combined in a kettle including firming salts, water and pectinase.

It is documented that raw garlic and onion will under specified process conditions cause a tomato product (i.e., a sauce) to gel. U.S. Pat. No. 4,547,375, to Mersfelder et al. addresses how to prevent these gels and/or use these types of gels to thicken tomato based products. Mersfelder et al. disclose using the gelation mechanism provided by releasing methyl pectin esterase from onion and garlic to demethoxylate the pectin available in the tomato based product to generate a supply of low methoxyl pectin to increase the viscosity of the sauce. They also disclose that in sauces wherein the tomatoes were initially heat treated to inactivate the enzymes, gelling can be prevented by, e.g., a) heating the onion or garlic prior to their addition to the sauce or b) the addition of pectinase.

Crandal et al. U.S. Pat. No. 5,206,047 recognized that high rapid heat treatment of pectin-containing juices will prevent gelling. Crandal et al. were confronted with the fact that the product they wanted to make could not tolerate a high heat manufacturing process without losing its product benefit. Their solution was to subject their product to high shear to destroy or prevent the gel. Unfortunately, high shear tends to destroy the appearance of distinct diced tomatoes in a sauce. Moreover, to subject a fresh pack tomato based sauce to sufficient heat in a short enough time to prevent some of the gelation would produce a product that lacked the flavor and texture benefits derived from making the product at lower temperatures, but results in the product having an undesirable texture because of the gel.

U.S. Pat. No. 4,418,090 (Bohrmann) discloses a prepared, dry food product having a thickening component, said food product being intended for reconstitution by direct addition to boiling aqueous liquid. The product includes a thickening component with a modified root starch or tuber starch having retarded thickening properties, wherein said modified starch is prepared by (a) heating native starch having a moisture content from about 16% to 35% by weight, in a closed system at a temperature from 55 C to about 135 C for a sufficient time period to impart to the starch the characteristic of retarded thickening, (b) cooling and drying the starch prepared in step (a).

U.S. Pat. No. 3,116,151 (Giddey) discloses a dispersible powdered ready-for-use food composition. Untreated starch is mixed into a melted fat component, dried and pressed into a cake, which is then grated and mixed with particles of soluble constituents. There is no heat-moisture treatment of the starch.

U.S. Pat. No. 2,909,431 (Keller) discloses a dry mix gravy-type food composition. The reference is specifically concerned with the problem of the lumping of starch when added to a hot liquid. The reference reports to overcome this problem by mixing native starch with a separating material, generally shortening, and some type of leavening ingredient.

U.S. Pat. No. 2,909,431 to Keller discloses a dry mix gravy-type food composition. The reference is specifically concerned with the problem of the lumping of starch when added to a hot liquid. The reference reports to overcome this problem by mixing native starch with a separating material, generally shortening, and some type of leavening ingredient.

U.S. Pat. No. 8,884,002 (Lundberg) that Pectinases, such as Pectinex™ Ultra SP-L (composed of the enzyme Polygatacturonase, a type of pectinase which is derived from Aspergillus aculeatus) or pectinmethylesterases were used to decrease or increase, respectively, the viscosity of fiber solutions, especially solutions with highly refined cellulosic thickeners, and particularly those made of highly refined cellulosic parenchyma cell wall fiber solutions. The enzyme can reduce the viscosity up to 95% or increase the viscosity 100 fold. At lower concentrations, the enzyme requires up to a few days of reacting to reach the full reduction in viscosity. In a method, the dry composition may include a refined cellulose fiber or refined cellulose particle including high parenchymal cell wall mass selected from the group consisting of citrus pulp, citrus peel, sugar beet pulp, banana pulp, mango pulp, apple pulp or fiber, passion fruit pulp and tomato pulp.

It is to be noted that much of this literature identifies some of the many problems that known classes of thickening agents have in preparing food products. It is therefore clear that additional and alternative methods and materials for addressing properties in tomato paste, tomato sauces, and products using tomato paste are desirable. All documents identified herein are incorporated by reference in their entirety.

### SUMMARY OF THE INVENTION

A method for adjusting the viscosity, binding any freewater/oil of a tomato sauce, replacing tomato solids with HRC and a resulting tomato sauce is prepared. Tomato paste solids are mixed with water, and spices (optional) to form a composition ready for processing into a sauce. A highly refined cellulose fiber or particle having a water holding capacity of at least 20 grams of water per gram of highly refined cellulose is mixed by agitation until uniformly mixed with the water and tomato paste mixture to form a pre-pasteurization mixture of tomato paste and at least 0.2% by weight of the highly refined cellulose. The pre-pasteurization mixture is pasteurized by heat to form a pasteurized mixture. While the hot pasteurized mixture is hot, it is homogenized. Pressure is increased during homogenization to increase viscosity and attain lower Bostwick consistency values.

### BRIEF DESCRIPTION OF THE FIGURES

FIG. 1 Bostwick consistency of tomato sauces processed at multiple pressures and usage rates.

FIG. 2: Thickness of samples made with 0.8% Citri-Fi 125FG at various homogenization pressures.

### DETAILED DESCRIPTION OF THE INVENTION

The present invention includes both a method of manufacturing a tomato sauce product and a tomato sauce product produced by the method which exhibits a range of properties. The natural tomato soluble solids (NTSS) can vary depending on the type of sauce being made, viscosity, and/or as described by the standard of identity. The method for adjusting the viscosity of a tomato sauce may generally be described as including:
a) mix tomato paste solids (31% NTSS, hot break) with water to adjust the NTSS to the desired quantity;
b) mix a highly refined cellulose fiber or particle having a water holding capacity of at least 20 grams H₂O per gram of highly refined cellulose fiber by agitation until uniformly mixed into a pre-pasteurization mixture comprising tomato paste and at least 0.2% by weight of the highly refined cellulose to total weight of tomato paste. Water is also preferably added to the mixture prior to pasteurization;
c) heat the s mixture to pasteurization conditions until at least about 160 F to form a pasteurized mixture;
d) while the hot pasteurized mixture is still over 120 F, move the hot pasteurized mixture through a homogenizer;
e) increase the confined pressure during homogenization from 0 pounds per square inch to a higher pressure. After homogenization with pressure, the Bostwick value is lowered by at least 5% to create a finished tomato sauce with its viscosity adjusted upwards from the viscosity of a sauce of the same ingredients homogenized at 0 pounds per square inch.
f) Unless using the sauce directly in a prepared meal or sauce, hot fill or aseptically fill the sauce into containers.

The method may be practiced wherein there is at least 0.4%, 0.5%, 0.6%, 0.7% and at least 0.8% by weight of the highly refined cellulose to total weight of tomato paste and the higher pressure during homogenization is at least 500 pounds per square inch (psi), preferably at least 100 psi, more preferably at least 1500 psi, and still more preferably at least 2000 psi or more than 2500 psi. The method may be practiced where there is at least 0.6% by weight of the highly refined cellulose to total weight of tomato paste and the higher pressure during homogenization is at least 500, 1000, 1500, 2000 or at least 2500 pounds per square inch. The method may be preferred with at least 0.2%-2 by weight of the highly refined cellulose to a total weight of tomato paste and the higher pressure during homogenization is at least 1500, at least 2000 or at least 2500 pounds per square inch.

The method may produce a finished tomato sauce which exhibits a Bostwick consistency of less than 5.5 after homogenization for at least 2 minutes, at least 5 minutes, at least 15 minutes or up to at least 30 minutes at 1500 pounds per square inch. After this portion of the method has been completed, the finished tomato sauce may be fed into a container (e.g., can, packet, jar, tetrapack, etc.) and the container is sealed, preferably hermetically. In this aspect of the method, the finished tomato sauce may be blended with additional sauce ingredients (herbs, spices, flavorings, vegetable chunks, meat, herbal leaves, onions, garlic, etc.) to form a final tomato sauce, and the final tomato sauce is fed into a container and the container is sealed.

The formulation of the invention also demonstrates how highly refined cellulose can replace or reduce the amount of natural tomato soluble solids (NTSS) contained in a sauce while maintaining the color, consistency, and desirable texture found in a higher NTSS formulation. Tests were tested that show how highly refined cellulose can replace from 5% to 40% of the NTSS while maintaining the color, taste and texture.

An edible tomato sauce product may include at least a) 0.2% (at least 0.3%, 0.4%, 0.5%, 0.6%, 0.7% or at least 0.8%) by weight highly refined cellulose having a water retention capacity of at least 20 grams of water per gram of (dry, e.g., less than 5% water in the highly refined cellulose) highly refined cellulose as compared to b) total weight of tomato paste in the edible tomato sauce product, wherein the edible tomato sauce product exhibits a Bostwick consistency of less than 5.5 at 20 C. The edible tomato sauce product of claim 16 further comprising herbs and spices.

The edible tomato sauce product may have at least 0.6% by weight of the highly refined cellulose as compared to the weight of tomato paste in the edible tomato sauce product and the edible tomato sauce exhibits a Bostwick consistency of less than 5.0 when tested at 20 C edible tomato sauce temperature. Or, the edible tomato sauce product may include a composition which consists essentially of tomato paste, water and the highly refined cellulose there is at least 0.6% by weight of the highly refined cellulose as compared to the weight of tomato paste in the edible tomato sauce product and the edible tomato sauce exhibits a Bostwick consistency of less than 5.0 when tested at 20 C edible tomato sauce temperature. Another novel property of using highly refined cellulose in a tomato sauce is the reduction of free water and oil. Highly refined cellulose is known to be both heat and shelf stable for long periods of time and samples tested with and without highly refined cellulose showed how both oil and/or water separated from the paste over time and this free water or oil can be significantly reduced or eliminated by adding small amounts of highly refined cellulose to the formulation.

Highly refined cellulose materials (HRC materials) are well known in the literature and are disclosed, for example, in U.S. patent application Ser. No.: 11/440,603, filed May 25, 2006, which is in turn a continuation-in-part of U.S. patent application Ser. No. 11/165,430, filed Jun. 30, 2005, titled “REDUCED FAT SHORTENING, ROLL-IN, AND SPREADS USING CITRUS FIBER INGREDIENTS,” which is a continuation-in-part of U.S. patent application Ser. No. 10/969,805, filed 20 Oct. 2004, and titled “HIGHLY REFINED CELLULOSIC MATERIALS COMBINED WITH HYDROCOLLOIDS,” which is a continuation-in-part of U.S. patent application Ser. No. 10/288,793, filed Nov. 6, 2002, titled “HIGHLY REFINED FIBER MASS, PROCESS OF THEIR MANUFACTURE AND PRODUCTS CONTAINING THE FIBERS.” The enzymatically modified highly refined cellulose fibers of U.S. patent application Ser. No. 12/958,118, filed 1 Dec. 2010 are also useful in the practice of the present technology, and that application is incorporated herein by reference in its entirety. Issued U.S. Patents of the inventor such as U.S. Pat. Nos. 8,399,040; 7,582,213; 7,094,300; and 6,506,435 as well as all documents cited herein are also incorporated by reference in their entirety.

According to the above cited U.S. patent application Ser. No. 13/914,181 (Lundberg), the HRC may also be accrued within a unique proprietary thickening agent described therein. That thickening composition may be made by a process of forming a highly refined cellulose and hydrocolloid product by, in order: a) providing a wet supply of natural, unrefined organic fibers, b) introducing a hydrocolloid to the supply of natural, unrefined organic fibers to form a mixture, c) shearing the mixture to refine the natural, unrefined organic fibers into highly refined cellulose blended with the hydrocolloid; and co-drying the highly refined cellulose blended with the hydrocolloid to form a highly refined cellulose fiber product having at least 10% by total weight of insoluble fiber. The hydrocolloid may be, for example, a base of guar, xanthan, carrageenan, or carboxymethyl cellulose.

The resulting product is a high parenchymal refined cellulose fiber additive product having a high parenchymal content fiber reagent that has organic fiber plant mass comprising at least 30% by weight of all fiber mass as parenchymal fiber mass and a hydrocolloid bound to the fiber during shearing of an unrefined cellulose fiber mass during formation of a highly refined cellulose mass as a high parenchymal fiber additive product having at least 10% by total weight of insoluble fiber. The product may also be described as a highly refined citrus fiber product comprising citrus fiber co-sheared and co-dried with at least 0.5% by weight hydrocolloid and comprising at least 10% by weight of insoluble citrus fiber. The high parenchymal fiber additive product may be based on a primary cell wall or parenchymal fiber product having at least 50% by weight of the fiber content of the natural, unrefined organic fibers as unbleached primary cell wall fiber or parenchymal fiber co-sheared and co-dried with at least 0.5% by weight of the parenchymal additive as hydrocolloid and the parenchymal fiber additive comprising at least 10% by weight of insoluble citrus fiber. The organic fiber mass comprises highly refined cellulose microfibers derived from organic fiber plant mass comprising at least 30% by weight of all fiber mass as parenchymal fiber mass, the highly refined cellulose product having a water retention capacity of at least about 5 g H₂O/g dry highly refined cellulose product, and the highly refined cellulose microfibers have a water retention capacity of at least 5 g H₂0/g dry highly refined cellulose product and the and the product further comprises less than 50% of the fiber and/or colored content of the fiber unbleached. The product may have the organic fiber mass of at least 50% by weight of fiber mass from organic products selected from the group consisting of sugar beets, citrus fruit, carrots, grapes, tomatoes, chicory, potatoes, pineapple, apples and cranberries and at least 80% of the organic fiber mass may be derived from fruit and root cell mass. The water retention capacity may also be at least 10 g H₂O/g dry highly refined cellulose product, at least 15 g H₂0/g dry highly refined cellulose product, at least 20 g H₂0/g dry highly refined cellulose product, and at least 25 g H₂0/g dry highly refined cellulose product and higher, with 40 or more g H₂0/g dry highly refined cellulose product.

A highly refined cellulose thickening or carrying composition for use with the present technology product comprising microfibers derived from organic fiber plant mass formed by shearing and physically may be in a non-refined natural, organic cellulosic fiber into the highly refined cellulosic fiber in the presence of at least one hydrocolloid present in a weight ratio of at least 1:10, hydrocolloid/microfiber, the highly refined cellulose product displaying a viscosity at a 1% by weight concentration in water at 1 revolution per minute of at least 20,000 centipoise at 20° C. The organic fiber plant mass may contain material from at least 50% by weight of fiber mass from organic products selected from the first group consisting of sugar beets, citrus fruit, carrots, grapes, tomatoes, chicory, potatoes, pineapple, apples and cranberries and wherein at least 80% of the organic mass is derived from fruit and root cell mass of the first group.

Another description of a method for refining cellulosic material from the fruit and plant materials for use in the practice of the present technology may include: soaking raw material from organic fiber plant mass comprising at least 50% by weight of all fiber mass as parenchymal fiber mass in an aqueous solution with less than 1% NaOH; draining the raw material and allowing the raw material to sit for sufficient time to enable cells in the raw material to open cells and expand the raw material into an expanded fiber product, the soaking producing soaked raw materials; and refining the soaked raw material to produce refined material by shearing the soaked raw materials in the presence of at least 10% by weight of hydrocolloid with respect to the weight of the organic fiber plant mass; and then drying the sheared mixture of highly refined cellulosic fiber and hydrocolloid.

A highly refined cellulosic material (e.g., cellulose, modified celluloses, derivatized celluloses, hemicellulose, lignin, etc.) provides desirable properties in edible compositions by themselves, but with the additional ability to provide controlled release and stable oil-bearing compositions, improving moisture retention, oil retention and absorbance, and product stability in both storage and in application of additives and edible compositions and cooked edible products. A preferred highly refined cellulose product can be prepared by generally moderate treatment and still provide properties that are equivalent to or improved upon the properties of the best highly refined cellulose products produced from more intense and environmentally unfriendly processes. Fruit or vegetable cells with an exclusively parenchymal cell wall structure can be treated with a generally mild process to form highly absorbent microfibers. Cells from citrus fruit and sugar beets are particularly available in large volumes to allow volume processing to generate highly refined cellulose fibers with both unique and improved properties. These exclusively parenchymal microfibers (hereinafter referred to as EPM's) have improved moisture retention and thickening properties that enable the fibers to provide unique benefits when combined into edible materials.

A proprietary process for making HRC cellulose from parenchyma cell wall products, e.g. citrus fruit and sugar beets by-products, is performed in the absence of a hydroxide soaking step. The product is able to display the same or improved water retention properties and physical properties of the more strenuously refined agricultural products of the prior art, and in some cases can provide even higher water retention values, thickening and other properties that can produce unique benefits in particular fields of use.

General descriptions of the invention include a highly refined cellulose product comprising microfibers derived from organic fiber plant mass. A preferred highly refined cellulose would contain at least 50% by weight of all fiber mass as parenchymal fiber mass, the highly refined cellulose product having a high level of water retention capacity, by way of non-limiting examples, of at least about 5, at least about 10, at least about 15, at least about 20 or at least about 25 g H₂O/g dry highly refined cellulose product. The highly refined cellulose product also may have a water retention capacity of at least 50 g H₂O/g dry highly refined cellulose product. A highly refined cellulose material when used in this patent is defined by a fiber material that has a total dietary fiber (TDF) content greater than 15%, or greater than 20%, or greater than 25% or greater than 30% as measured by AOAC 991.43 and a water holding capacity greater than three, four or five parts water per part fiber as measured by AACC 56-30, followed literally or with the modification of testing a 2.5 gram fiber sample instead of a 5 gram fiber sample, and is less than 50%, 75% or less than 90% soluble fiber. One example of a highly refined cellulose that fits within this definition is a product from Fiberstar, Inc. (Willmar, Minn.) called Imulsi-Fi.™ citrus fibers or additive. There are three types of Imulsi-Fi.™ products, and they include 1) Imulsi-Fi A40, which only contains dried orange pulp, 2) Imulsi-Fi™ B40 additive, which only contains dried orange pulp and guar gum (a hydrocolloid), and 3) Imulsi-Fi™ C40, which only contains dried orange pulp and xanthan gum (a hydrocolloid). 1) The dried orange pulp in the Imulsi-Fi™ additive products is derived from parenchyma cell wall material. Parenchymal cell walls refer to the soft or succulent tissue, which is the most abundant cell wall type in edible plants. For instance, in sugar beets, the parenchyma cells are the most abundant tissue the surrounds the secondary vascular tissues (xylem and phloem). Parenchymal cell walls contain relatively thin cell walls compared to secondary cell walls are tied together by pectin (Haard and Chism, 1996, Food Chemistry. Ed. By Fennema. Marcel Dekker NY, N.Y.) In secondary cell walls (xylem and phloem tissues), the cell walls are much thicker than parenchymal cells and are linked together with lignin. This terminology is well understood in the art.

As used in the practice of the present invention, the term “dry” or “dry product” refers to a mass that contains less than 15% by weight of fibers as water. The organic fiber mass comprises at least 50% by weight of fiber mass from organic products selected from the group consisting of sugar beets, citrus fruit, grapes, tomatoes, chicory, potatoes, pineapple, apple, carrots and cranberries. A cosmetic product or cosmetic additive may have at least 0.05 percent by weight solids in the cosmetic product or cosmetic additive of the above described highly refined cellulose product. The cosmetic product may also have at least about one-half percent, one percent or at least about two percent by weight of the highly refined cellulosic fiber of the invention.

A method for refining cellulosic material may comprise: a) soaking raw material from organic fiber plant mass comprising at least 50% by weight of all fiber mass as parenchymal fiber mass in an aqueous solution with less than 1% NaOH; b) draining the raw material and allowing the raw material to sit for a sufficient period under conditions (including ambient conditions of room temperature and pressure as well as accelerated conditions) so that the fibers and cells are softened so that shearing can open up the fibers to at least 40%, at least 50%, at least 60%, or at least 70, 80, 90 or 95% of their theoretic potential. This will usually require more that 4 hours soaking to attain this range of their theoretic potential. It is preferred that this soaking is for more than 5 hours, and preferably for at least about 6 hours. This soaking time is critical to get the materials to fully soften. When such a low alkaline concentration is used in the soaking, without the set time, the materials do not completely soften and cannot be sheared/opened up to their full potential. This process produces soaked raw materials; and the process continues with refining the soaked raw material to produce refined material; and drying the soaked raw material.

The process may perform drying by many different commercial methods, although some display improved performance in the practice of the present invention. It is preferred that drying is performed, at least in part, by fluid bed drying or flash drying or a combination of the two. An alternative drying process or another associated drying step is performed at least in part by tray drying. For example, fluid bed drying may be performed by adding a first stream of organic fiber plant mass and a second stream of organic fiber plant mass into the drier, the first stream having a moisture content that is at least 10% less than the moisture content of the second stream or organic fiber plant mass. The use of greater differences in moisture content (e.g., at least 15%, at least 20%, at least 25%, at least 40%, at least 50% weight-to-weight water percent or weight-to-weight water-to-solid percent) is also within the scope of practice of the invention. In the drying method, the water may be extracted with an organic solvent prior to drying. In the two stream drying process, the second stream of organic fiber plant mass may have at least 25% water to solids content and the first stream may have less than 15% water to solids content. These processes may be practiced as batch or continuous processes. The method may use chopping and washing of the cellulose mass prior to soaking.

Another description of a useful process according to the invention may include draining and washing the soaked raw material in wash water to produce washed material; bleaching the washed material in hydrogen peroxide to produce a bleached material; and washing and filtering the bleached material to produce a filtered material.

The drying of an expanded fiber material according to the invention may use room temperature or higher air temperatures that dry the expanded fiber product and maintain the fiber material's functionalities of at least two characteristics of surface area, hydrogen bonding, water holding capacity and viscosity. This can be particularly performed with a method that uses a fluid bed dryer or flash dryer to dry the expanded or highly refined cellulosic fiber product.

The use of a flash or fluid bed dryer is an advantage over the drying methods suggested by the prior art. We have found that through the use of a fluid bed or flash dryer, low temperatures and controlled humidity are not needed to dry the materials of the present invention. In fact, although nearly any drying temperature in the fluid bed or flash dryer can be used, we have dried the product of the present invention using high air temperatures (400.degree. F.) and attained a dry product with near equivalent functional properties after rehydration compared to the materials before drying. Additionally, using the process of the present invention, any surface area expanded cellulosic product can be dried and a functional product obtained and is not limited to parenchyma cell wall materials. The use of a fluid bed or flash dryer, the use of relatively high drying air temperatures (400 F+), and the ability to dry non parenchyma cell wall (secondary cell) and obtain a functional product is in great contrast to the relatively low temperatures, e.g. 100 C (212 F) and dryer types taught by conventional methods to dry expanded parenchymal cell wall materials. Other methods are also less energy efficient and time efficient, such as freeze drying (Gu et al, 2001). E.g., from (Gu, L., R Ruan, P. Chen, W. Wilcke, P. Addis. 2001. Structure Function Relationships of Highly Refined Cellulose. Transactions of the ASAE. Vol 44(6):1707-1712). Freeze drying is not an economically feasible drying operation for large volumes of expanded cell wall products.

The fiber products of the invention may be rehydrated or partially rehydrated so that the highly refined cellulose product is rehydrated to a level of less than 90 g H.sub.2O/g fiber mass, 70 g H₂O/g fiber mass, 50 g H₂O/g fiber mass or rehydrated to a level of less than 30 g H₂O/g fiber mass or less than 20 g H₂O/g fiber mass. This rehydration process adjusts the functionalities of the product within a target range of at least one property selected from the group consisting of water holding capacity, oil holding capacity, and viscosity and may include the use of a high shear mixer to rapidly disperse organic fiber plant mass materials in a solution. Also. the method may include rehydration with soaking of the dry materials in a solution with or without gentle agitation.

The basic process of the invention may be generally described as providing novel and improved fiber waste by-product from citrus fruit pulp (not the wood and stem and leaves of the trees or plant, but from the fruit, both pulp and skin) or fiber from sugar beet, tomatoes, chicory, potatoes, pineapple, apple, cranberries, grapes, carrots and the like (also exclusive of the stems, and leaves). The provided fiber mass is then optionally soaked in water or aqueous solution (preferably in the absence of sufficient metal or metallic hydroxides e.g., KOH, CaOH, LiOH and NaOH) as would raise the pH to above 9.5, preferably in the complete absence of such hydroxides (definitely less than 3.0%, less than 1.0%, more often less than 0.9%, less than 0.7%, less than 0.5%, less than 0.3%, less than 0.1%). The soaked material is then drained and optionally washed with water. This is optionally followed by a bleaching step (any bleaching agent may be used, but mild bleaching agents that will not destroy the entire physical structure of the fiber material is to be used (with hydrogen peroxide a preferred example, as well as mild chlorine bleaches). It has also been found that the bleach step is optional, but that some products require less color content and require bleaching. The (optionally) bleached material is washed and filtered before optionally being subjected to a shredding machine, such as a plate refiner which shreds the material into micro fibers. The optionally soaked, bleached, and refined material is then optionally dispersed, and homogenized at high pressure to produce HRC gel.

The HRC dispersion of the present invention is a highly viscous, semi-translucent gel. HRC embodiments comprise dried powders that are redispersable in water to form gel-like solutions. The functional characteristics of HRC are related to various properties, including water- and oil-retention capacity, average pore size, and surface area. These properties inherently relate to absorption characteristics, but the properties and benefits provided by the processes and products of the invention seem to relate to additional properties created in the practice of the invention.

The present invention also includes an aqueous HRC gel having a lignin concentration of about one to twenty percent (1 to 20%). The HRC products of the present invention exhibit a surprisingly high WRC in the range of about 20 to at least about 56 g H₂O/g dry HRC. This high WRC is at least as good as, and in some cases, better than the WRC of prior art products having lower or the same lignin concentrations. The HRC products exhibit some good properties for ORC (oil retention capacity).

A general starting point for a process useful in manufacturing preferred HRC materials is to start with raw material of sufficiently small size to be processed in the initial apparatus (e.g., where soaking or washing is effected), such as a soaker or vat. The by-product may be provided directly as a result of prior processing (e.g., juice removal, sugar removal, betaine removal, or other processing that results in the fiber by-product. The process of the present invention may also begin when raw material is reduced in size (e.g., chopped, shredded, pulverized) into pieces less than or equal to about 10×5 cm or 5 cm×2 cm. Any conventional type of manual or automated size reduction apparatus (such as chopper, shredder, cutter, slicer, etc.) can be used, such as a knife or a larger commercially-sized chopper. The resulting sized raw material is then washed and drained, thus removing dirt and unwanted foreign materials. The washed and chopped raw material is then soaked. The bath is kept at a temperature of about 20 to 100° C. The temperature is maintained within this range in order to soften the material. In one embodiment, about 100 g of chopped raw material is soaked in a 2.5 liter bath within a temperature range of about 20 to 80° C. for 10 to 90 minutes.

The resulting soaked raw material is subjected to another washing and draining. This washing and additional washing and draining tend to be more meaningful for sugar beets, potatoes, carrots (and to some degree also tomatoes, chicory, apple, pineapple, cranberries, grapes, and the like) than for citrus material. This is because sugar beets, potatoes, carrots, growing on the ground rather than being supported in bushes and trees as are citrus products, tend to pick up more materials from the soil in which they grow. Sugar beets and carrots tend to have more persistent coloring materials (dyes, pigments, minerals, oxalates, etc.) and retained flavor that also are often desired to be removed depending upon their ultimate use. In one embodiment, the soaked raw material is washed with tap water. In one other embodiment, the material is drained. This is optionally followed by bleaching the material with hydrogen peroxide at concentrations of about one (1) to 20% (dry basis) peroxide. The bleaching step is not functionally necessary to effect the citrus and grape fiber conversion to highly refined cellulose. With respect to carrots and sugar beets, some chemical processing may be desirable, although this processing may be significantly less stressful on the fiber than the bleaching used on corn-based HRC products. From our experience, some chemical step is required for sugar beets, and bleaching is one option. Using alkaline pretreatment baths is another option. Acid treatment or another bleaching agent are other options.

The material is optionally bleached at about 20 to 100° C. for about five (5) to 200 min. The bleached material is then subjected to washing with water, followed by filtering with a screen. The screen can be any suitable size. In one embodiment, the screen has a mesh size of about 30 to 200 microns. The filtered material containing solids can then be refined (e.g., in a plate refiner, stone mill, hammer mill, ball mill, or extruder.). In one embodiment, the filtered material entering the refiner (e.g., a plate refiner) contains about four percent (4%) solids. In another embodiment, the refining can take place in the absence of water being added. The plate refiner effectively shreds the particles to create microfibers. The plate refiner, which is also called a disk mill, comprises a main body with two ridged steel plates for grinding materials. One plate, a refining plate, is rotated while a second plate remains stationary. The plates define grooves that aid in grinding. One plate refiner is manufactured by Sprout Waldron of Muncy, Pa. and is Model 12-ICP. This plate refiner has a 60 horsepower motor that operates at 1775 rpm.

Water may be fed into the refiner to assist in keeping the solids flowing without plugging. Water assists in preventing the refiner's plates from overheating, which causes materials in the refiner to burn. (This is a concern regardless of the type of grinding or shearing device used.). The distance between the plates is adjustable on the refiner. To set refining plate distances, a numbered dial was affixed to the refining plate adjustment handle. The distance between the plates was measured with a micrometer, and the corresponding number on the dial was recorded. Several plate distances were evaluated and the setting number was recorded. A variety of flow consistencies were used in the refiner, which was adjusted by varying solids feed rate. The amount of water flowing through the refiner remained constant. Samples were sent through the refiner multiple times. In one embodiment. the materials are passed one or more times through the plate refiner.

The microfibers may then be separated with a centrifuge to produce refined materials. The refined materials are then diluted in water until the solids content is about 0.5 to 37%. This material is then dispersed. In one embodiment, dispersing continues until a substantially uniform suspension is obtained, about 2 to 10 minutes. The uniform suspension reduces the likelihood of plugging. The resulting dispersed refined materials, i.e., microparticles, may then be homogenized in any known high pressure homogenizer operating at a suitable pressure. In one embodiment, pressures greater than about 5,000 psi are used. The resulting highly refined cellulose (HRC) gel may display a lignin content of about 1 to 20% by weight, depending in part upon its original content.

The absence of use of a mild NaOH soaking before the refining step in the present invention prior to high pressure homogenization does not require the use of high temperature and high pressure cooking (high temperature means a temperature above 100° C. and high pressure means a pressure above 14 psi absolute). High temperature and high pressure cooking may be used, but to the disadvantage of both economics and output of the product. This novel process further avoids the need for either mild concentrations of NaOH or of highly concentrated NaOH and the associated undesirable environmental impact of discharging waste water containing any amount of NaOH and organic compounds. The process also avoids a need for an extensive recovery system. In one embodiment, the pH of the discharge stream in the present invention is only about 8 to 9 and may even approach 7. The method of the present invention has the further advantage of reducing water usage significantly over prior art processes, using only about one third to one-half the amount of water as is used in conventional processes to produce to produce excellent HRC gel and amounts

All of the mechanical operations, refining, centrifuging, dispersing, and homogenizing could be viewed as optional, especially in the case of citrus pulp or other tree bearing fruit pulps. Additionally, other shearing operations can be used, such as an extruder, stone mill, ball mill, hammer mill, etc. For citrus pulp, the only processes that are needed to produce the expanded cell structure are to dry (using the novel drying process) and then properly hydrate the raw material prior to the expanding and shearing step of the process of the invention. This simple process could also be used in other raw material sources.

Hydration is a term that means reconstituting the dried fiber back to a hydrated state so that it has functionality similar to the pre-dried material. Hydration can be obtained using various means. For instance, hydration can occur instantly by placing the dry products in a solution followed by shearing the mixture. Examples of shearing devices are a high shear disperser, homogenizer, blender, ball mill, extruder, or stone mill. Another means to hydrate the dry materials is to put the dry product in a solution and mix the materials for a period of time using gentle or minimal agitation. Hydrating dry materials prior to use in a recipe can also be conducted on other insoluble fibrous materials to enhance their functionality.

In another embodiment, the HRC products of the present invention possess a WRC and ORC that are at least as good as or even better than prior art products with regard to the water retention characteristics and the strength of that retention. This is true even though the products of the present invention may have a higher lignin concentration than products made using conventional processes and are dried. It is assumed that the lignin which is present has been substantially inactivated to a sufficient degree so that the undesirable clumping does not subsequently occur. Another reason for these improved properties may be due to a porous network structure that is present in the HRC products of the present invention, but is lost in prior art products due to high concentration soaking in NaOH, and which may be slightly reduced even with the mild NaOH solutions used by the Lundberg patents.

A number of unexpected properties and benefits have been provided by the highly refined cellulose microfiber product of the present invention derived from parenchymal cell material. These products are sometimes referred to herein as “exclusively parenchymal cell wall structures.” This is indicative of the fact that the majority source of the material comes from the cell structures of the plants that are parenchymal cells. As noted earlier, the HRC microfibers of the invention are not produced by mild treatment of the leaves, stems, etc. of the plants (which are not only parenchymal cell wall structures, but have much more substantial cell structures). This does not mean that any source of citrus or beet cells and fibers used in the practice of the present invention must be purified to provide only the parenchymal cells. The relative presence of the more substantive cells from leaves and stems will cause approximately that relative proportion of cell or fiber material to remain as less effective material or even material that is not converted to HRC, but will act more in the nature of fill for the improved HRC microfibers of the present invention. It may be desirable in some circumstances to allow significant portions of the more substantive cells and fibers to remain or even to blend the HRC (citrus or beet parenchyma based) product of the present invention with HRC fibers of the prior art to obtain particularly desired properties intermediate those of the present invention and those of the prior art. In the primary manufacturing process of the invention (that is, the process wherein the cells that have essentially only parenchymal cell walls are converted to HRC microfibers or particles according to the mild treatment process of the present invention), the more substantive cells and fibers may be present in weight proportions of up to fifty percent (50%). It is preferred that lower concentrations of the more substantive fibers are present so as to better obtain the benefit of the properties of the HRC fibers of the present invention, so that proportions of cells having exclusively parenchymal cell walls in the batch or flow stream entering the refining process stream constitute at least 50%, at least 60%, at least 70%, at least 80%, at least 90%, at least 95%, at least 97%, at least 98%, at least 99% or preferable about 100% of the fibrous or cellular material added to the refining flow stream. The final fiber product should also contain approximately like proportions of the HRC product of the present invention with regard to other HRC additives or fiber additives.

Among the unexpected properties and benefits of the HRC materials of the present invention derived from the mild refinement of cells and fiber from citrus and beet by-product are the fact of the HRC fibers, the stability of HRC fibers from parenchymal cells, the high water retention properties, the strength of the water retention properties of the fibers, the ability of the HRC fibers to retain water (moisture) even when heated, the ability of the HRC fibers to retain water (moisture) on storage, and the ability of the HRC fibers to retain moisture in cosmetics products without promoting degradation, deterioration or spoilage of the cosmetic as compared to cosmetics with similar concentrations of moisture present in the product that is not bound by HRC fibers. The ability of the fiber materials of the present invention to retard moisture migration is also part of the benefit. This retarded water migration and water activity of water retained or absorbed by the fibers of the invention may be related to the previously discussed binding activity and binding strength of water by the fiber. As the moisture is retained away from other ingredients that are more subject to moisture-based deterioration, the materials of the invention provide significant benefits in this regard. The HRC fiber materials of the present invention provide other physical property modifying capabilities in the practice of the invention. For example, the fibers can provide thickening properties, assist in suspending or dispersing other materials within a composition, and the like. These properties are especially present in HRC fibers of the invention provided from sugar beets and citrus products.

Consideration of the following examples will assist in understanding the nature of the invention.

As background, the Bostwick Consistometer is a preferred choice for measuring consistency and flow rate in a variety of products. Moderately skilled technicians can use the “Bostwick” on any viscous material such as sauces, salad dressings, paints, chemicals or cosmetics. The normal way to use the Consistometer is to measure the distance a sample flows in a given time interval.

The “Bostwick” is a commercially available (from numerous suppliers) long trough with 0.5 cm graduations along the bottom. The trough is separated near one end by a spring-loaded gate. This forms a chamber where the sample is loaded. To perform a test, first a sample is loaded, then the gate is opened and a timer is started. At a predetermined time, the position of the sample in the trough is recorded.

The recommended standards for products are optional and may be tailored by users for specific types of products. Each customer sets their own standards and operating procedures based on the individual characteristics of their products. For purposes of the present invention, so as to specifically identify specifications, we have used:

Trough Length: 14½ inches with 60 etched 0.5 cm graduations.

Sample Reservoir Capacity: 75 ml

Overall Length: 17 inches. Overall Width: 3¼ inches. Weight: 2 pounds.

Leveling: 2-leveling screws and spirit level.

The “Bostwick” also complies with the procedures established in Mill Spec R-81294D and ASTM F1080-93. The Bostwick reading is a measure of how far the given sample will flow along the trough in a fixed amount of time (e.g., one minute) at standard atmospheric pressure (760 mm Hg. 1 atmosphere) and 20C (room temperature, 68F). The longer the distance, the lower the viscosity, and the shorter the distance the material has flowed down the trough, the higher the viscosity).

The “Bostwick” Consistometer is built for ease of operation and heavy duty use. The unit is made from stainless steel which resists corrosion. To clean it after a test, simply wash it out with water. The spring-loaded gate makes the start of a test instantaneous and precise. The leveling screws and spirit level insure proper set-up. The unit of measure derived from the Bostwick consistometer is the number of 0.5 graded units in the trough that the leading edge of the flow covers, with the trough in a level position, within the test time period (e.g., one minute at 20C and 1 atmosphere).

### EXAMPLE 1

Procedure:

1. Reduce tomato paste solids content by adding water, or mix vigorously in a Likwifier® blender or similar batching tank.

2. Mix in Citri-Fi™ 125FG additive with slow addition and good agitation until uniformly mix.

3. Heat to pasteurization conditions until 165 F.

4. While still hot, pump through a homogenizer at various pressures.

5. Hot fill or aseptically fill into containers, or alternatively use directly as an ingredient in a downstream product such as a prepared meal or another sauce or condiment.

Example formulation to attain 12% rix brand tomato paste solids and 0.2% Citri-Fi™ 125FG additive.

| | Control | | Citri-Fi 125 | |
|---|---|---|---|---|
| | 0.0% Citri-Fi ™ | | 0.2% Citri-Fi ™ | |
| Simple Enhanced | 125FG additive | | 125FG additive | |
| Tomato Sauce | pounds | % | pounds | % |
| Tomato Paste | 96.78 | 38.7 | 96.58 | 38.6 |
| (31% NTSS, HB) | | | | |
| Water | 153.23 | 61.3 | 152.92 | 61.2 |
| Citri-Fi ™ 125FG | 0.00 | 0.0 | 0.50 | 0.2 |
| Total | 250.00 | 100.0 | 250.00 | 100.0 |

Results:

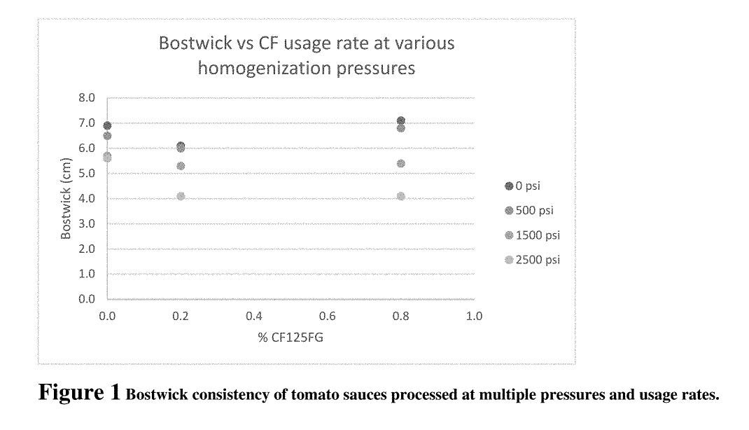

The use of Citri-Fi® 125 additive (or CF125) at various levels was found to increase consistency but not in an expected way. For instance, at lower usage levels, e.g. 0.2%, there was a clear increase in consistency and viscosity of the paste. As shown in FIG. 1, the Bostwick consistency of the control being processed at 2500 psi homogenization pressure was at 5.6 cm but with 0.2% CF125FG, the Bostwick consistency decreased to 4.1 cm, meaning the viscosity increased. However, at the 0.8% CF125FG usage level, the Bostwick consistency remained at 4.1 cm and did not change compared to the lower usage rate. There is only a theory as to why this occurs, but this should not limit the scope of the invention. This effect could be due higher usage rates causing an interference in the tomato's structure resulting in less viscosity increase versus the lower usage rate which will just bind free water without interrupting network.

### EXAMPLE 2

A similar procedure and same formulation was shown as in FIG. 1 but the amount of Citri-Fi™ 125 additive was fixed at 0.8% and only the homogenization pressure varied. The procedure is outlined below.

Procedure:

1. Reduce tomato paste solids content by adding water, or mix vigorously in a Likwifier™ blender or similar batching tank.

2. Mix in 0.8% Citri-Fi™ 125FG additive with slow addition and good continuous agitation until uniformly mix.

3. Heat to pasteurization conditions until about 165° F.

4. While still hot, pump the pasteurized mixture through a homogenizer at pressures of 0, 500, 1500, and 2500 psi.

5. Hot fill or aseptically fill into containers, or alternatively use directly as an ingredient in a downstream product such as a prepared meal or another sauce or condiment.

Results:

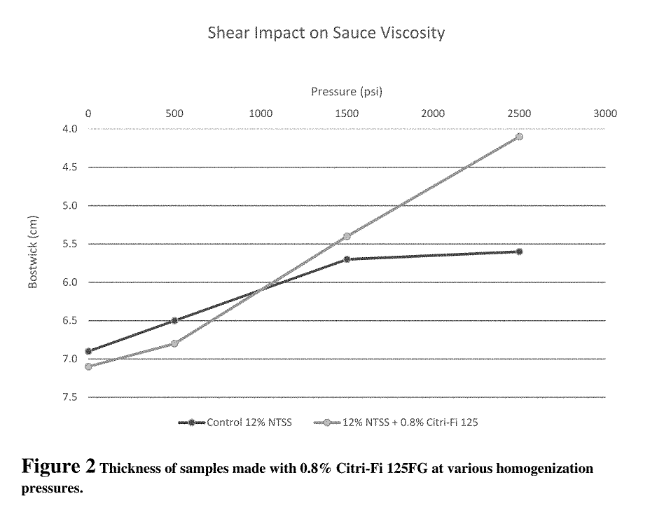

An unexpected relationship occurred between the homogenization pressure and the thickness of the paste. At a lower pressure of 0 or 500 psi, the samples with Citri-Fi™ additive were thinner (meaning the Bostwick consistency was higher) than the control. However, as the homogenization pressure increased, this helped form a more solid network for the Citri-Fi™ additive to function in as the thickness of the tomato sauce solids continued to increase. The decrease in Bostwick consistency was over 12% (as much as 18% or more) at 2500 psi (as between 0.2 Citri-Fi™ additive concentration versus 0.8% Citri-Fi™ additive concentration), even though the Bostwick consistency was the same with prolonged mixing at 0 and 500 psi pressure for both concentrations. This synergistic increase in Botwickconsistency at higher shearing was believed to begin at 0.4%, and definitely was present at 0.6% This occurred even as the homogenization pressure increased even though the amount of Citri-Fi™ aditive stayed the same. Although the control's thickeness increased as well at higher pressures, the rate of change and increase wasn't nearly as dramatic as Citri-Fi™ additive tests. In other words, while the thickness of the 0.8% Citri-Fi™ additive test was less than the control at lower pressures, at homogenization pressures of 1500 psi and 2500 psi, the samples made with Citri-Fi™ additive had more thickness compared to the control. This means that when using the highly refined cellulose (HRC) having the properties of Citri-Fi™ additives, thicker sauces can be made with smaller levels of HRC additive than predicatble. The benefits of increased viscosity (lower Bostwick consistency) was therefore a part of the present invention at at least 0.5% (total weight solids or total weight of tomato solids), preferably at least 0.6%, at least 0.7%, at least 0.8% or at least 0.9% total weight solids or total weight of tomato solids. More than 0.9% up to 5% or even 8% total Citri-Fi™ additive solids per total weight of solids or total weight of tomato solids may be used. Another important attribute of the tests made with Citri-Fi was that the color was the same as the controls, which is unusual considering the color of Citri-Fi is not red like a tomato sauce. Without limiting the scope of invention, is thought that the low usage level and absorbent cell wall structure is able to blend in with the tomato solids in such a way without negatively impacting the sauce's color. The results are shown below in FIG. 2.

### EXAMPLE 3

A similar procedure and same formulation was shown as in EXAMPLE 1 AND EXAMPLE 2 but the control (at 11.6% NTSS) with no highly refined cellulose was compared to tomato sauces that had 0.3% Citri-Fi 125FG with three different NTSS levels: 11.2%, 9.7%, and 9.1%. The same process procedure as outlined in the above examples were followed by the homogenization pressure was kept fixed for all samples at 2500 psi.

The results are for the reduced NTSS samples made with Citri-Fi 125FG are shown below. An unexpected result from this testing was that the Bostwick consistency values for each tests was the same even though the samples made with Citri-Fi 125FG had less NTSS. This further demonstrates the thickening and binding properties of highly refined cellulose. Another important attribute of the tests made with Citri-Fi was that the color was the same as the control, which is unusual considering the color of Citri-Fi is not red like a tomato sauce and in this example, tomato solids were also reduced.

| | % Citri-Fi | Bostwick value |
|---|---|---|
| NTSS | 125FG | at 20 C. (cm) |
| 11.6% | 0% | 4.6 |
| 11.2% | 0.3% | 4.3 |
| 9.7% | 0.3% | 6.2 |
| 9.1% | 0.3% | 5.1 |

### EXAMPLE 4

A similar procedure and same formulation was shown as in EXAMPLE 1, 2 & 3, but a cold break tomato paste was used and water added to attain 12 brix. For the control, no highly refined cellulose was added but for the test 0.3% highly refined cellulose (Citri-Fi 100 was added) primarily for thickening but also to see if free moisture could be reduced. Both samples were well mixed for 15 minutes without homogenization. An unexpected result from this testing was that the Bostwick consistency values for each tests was similar but there was dramatically less free moisture in the test containing highly refined cellulose. When a small sample was placed on a piece of filter, there was approximately 50% less area of free moisture bled into the filter paper for the sample made with highly refined cellulose versus a control. The testing demonstrates the ability to use highly refined cellulose to not only thicken sauces, reduce NTSS as shown in the previous samples, but also to reduce free moisture separation.

### EXAMPLE 5

The same procedure and formulation as shown as in EXAMPLE 1, 2 & 3 was made but a cold break tomato paste was used. Water was added to attain a paste 12 brix and 10% oil was also added for additional flavoring of the sauce for both the control and test formulas. For the control, no highly refined cellulose was added but for the test, Citri-Fi 100FG was added at 0.5%. In the control, after one week there was noticeable free oil separation floating on the top of the sauce but for the test made with Citri-Fi, no free oil was noticed as the sauce remained completely uniform without any free oil. This test showed the ability to bind free oil in addition to the prior example where highly refined cellulose was added to bind free moisture.

What is claimed:

1. A method for adjusting the viscosity and binding of a tomato sauce comprising:
a) Mixing tomato paste solids with water;
b) Mixing a highly refined cellulose fiber or particle having a water holding capacity of at least 5 g H₂0/g dry highly refined cellulose product by agitation until uniformly mixed into a pre-pasteurization mixture comprising tomato paste and at least 0.2% by weight of the highly refined cellulose to total weight of tomato paste;
c) Heating the pre-pasteurization mixture to pasteurization conditions until at least 160 F to form a pasteurized mixture;
is d) While the hot pasteurized mixture is over 120F, move the hot pasteurized mixture through a homogenizer;
e) Increasing pressure during homogenization from 0 pounds per square inch to a higher pressure where Bostwick consistency is lowered by at least 5% to create a finished tomato sauce with its viscosity adjusted upwards from the viscosity of a sauce of the same ingredients homogenized at 0 pounds per square inch.

2. The method of claim 1 wherein there is at least 0.4% by weight of the highly refined cellulose to total weight of tomato paste and the higher pressure during homogenization is at least 500 pounds per square inch.

3. The method of claim 1 wherein there is at least 0.6% by weight of the highly refined cellulose to total weight of tomato paste and the higher pressure during homogenization is at least 1000 pounds per square inch.

4. The method of claim 1 wherein there is at least 0.8% by weight of the highly refined cellulose to total weight of tomato paste and the higher pressure during homogenization is at least 1500 pounds per square inch.

5. The method of claim 1 wherein the finished tomato sauce exhibits a Bostwick consistency of less than 5.5 after homogenization for 30 minutes at 1500 pounds per square inch.

6. A method of claim 1 where the tomato sauce made with at least 0.2% highly refined cellulose has reduced natural tomato soluble solids (NTSS) but has equal or more viscosity as measured by a Bostwick consistometer compared to a control sauce with higher NTSS.

7. A method of claim 1 where the tomato sauce made with at least 0.2% highly refined cellulose has at least 1% less water separation and/or oil separation compared to a control with no highly refined cellulose.

8. The method of claim 3 wherein the finished tomato sauce exhibits a Bostwick consistency of less than 5.5 after homogenization for 30 minutes at 1500 pounds per square inch.

9. The method of claim 4 wherein the finished tomato sauce exhibits a Bostwick consistency of less than 5.5 after homogenization for 30 minutes at 1500 pounds per square inch.

10. The method of claim 1 wherein the finished tomato sauce is fed into a container and the container is sealed.

11. The method of claim 8 wherein the finished tomato sauce is fed into a container and the container is sealed.

12. The method of claim 9 wherein the finished tomato sauce is fed into a container and the container is sealed.

13. The method of claim 1 wherein the finished tomato sauce is blended with additional sauce ingredients to form a final tomato sauce, and the final tomato sauce is fed into a container and the container is sealed.

14. The method of claim 8 wherein the finished tomato sauce is blended with additional sauce ingredients to form a final tomato sauce, and the final tomato sauce is fed into a container and the container is sealed.

15. The method of claim 9 wherein the finished tomato sauce is blended with additional sauce ingredients to form a final tomato sauce, and the final tomato sauce is fed into a container and the container is sealed.

16. An edible tomato sauce product comprising at least a) 0.2% by weight highly refined cellulose having a water retention capacity of at least 20 grams of water per gram of highly refined cellulose as compared to b) total weight of tomato paste in the edible tomato sauce product, wherein the edible tomato sauce product exhibits a Bostwick consistency of less than 5.5 at 20 C.

17. The edible tomato sauce product of claim 16 wherein there is at least 0.6% by weight of the highly refined cellulose as compared to the weight of tomato paste in the edible tomato sauce product.

18. The edible tomato sauce product of claim 16 wherein there is at least 0.8% by weight of the highly refined cellulose as compared to the weight of tomato paste in the edible tomato sauce product.

19. A method of claim 16 where the tomato sauce made with at least 0.2% highly refined cellulose has at least 1% less water separation and/or oil separation compared to a control with no highly refined cellulose.

20. A method of claim 16 where the tomato sauce made with at least 0.2% highly refined cellulose has reduced natural tomato soluble solids (NTSS) but has equal or more viscosity as measured by a Bostwick consistometer compared to a control sauce with higher NTSS.

21.

22. The edible tomato sauce product of claim 15 further comprising herbs and spices.

23. The edible tomato sauce product of claim 16 further comprising herbs and spices.

24. The edible tomato sauce product of claim 14 wherein there is at least 0.6% by weight of the highly refined cellulose as compared to the weight of tomato paste in the edible tomato sauce product and the edible tomato sauce exhibits a Bostwick consistency value of less than 5.0 when tested at 20 C.

25. The edible tomato sauce product of claim 14 wherein the edible tomato sauce product consists essentially of tomato paste, water and the highly refined cellulose there is at least 0.6% by weight of the highly refined cellulose as compared to the weight of tomato paste in the edible tomato sauce product and the edible tomato sauce exhibits a Bostwick consistency value of less than 5.0 when tested at 20 C edible tomato sauce temperature.

26. The edible tomato sauce product of claim 16 wherein the edible tomato sauce product consists essentially of tomato paste, water and the highly refined cellulose as at least 0.8% by weight of the highly refined cellulose as compared to the weight of tomato paste in the edible tomato sauce product. and the edible tomato sauce product exhibits a Bostwick consistency value of less than 5.0 when tested at 20 C edible tomato sauce temperature.
